(19) United States
(12) Patent Application Publication
(10) Pub. No.: US 2013/0304961 A1
(43) Pub. Date: Nov. 14, 2013

(54) HUB CONTROL CHIP

(71) Applicant: VIA TECHNOLOGIES, INC., New Taipei City (TW)

(72) Inventors: Hsiao-Chyi LIN, New Taipei City (TW); Wen-Yu TSENG, New Taipei City (TW)

(73) Assignee: VIA TECHNOLOGIES, INC., New taipei City (TW)

(21) Appl. No.: 13/889,597

(22) Filed: May 8, 2013

Related U.S. Application Data
(60) Provisional application No. 61/644,526, filed on May 9, 2012.
(60) Provisional application No. 61/692,689, filed on Aug. 23, 2012.

(30) Foreign Application Priority Data
Apr. 11, 2013 (TW) 102112809

(51) Int. Cl. G06F 13/40

(52) U.S. Cl. CPC G06F 13/409
USPC 710/313

(57) ABSTRACT

A HUB control chip implemented in a specific package is provided. The HUB control chip includes a plurality of transmission modules and a plurality of pins. The plurality of the pins include: a plurality of data pin groups coupled to one of the plurality of transmission modules respectively. Each of the plurality of data pin groups includes: a first sub-group, receiving and transmitting a first pair of differential signals conforming to the USB 2.0 standard; a second sub-group, receiving a second pair of differential signals conforming to the USB 3.0 standard; and a third sub-group, transmitting a third pair of differential signals conforming to the USB 3.0 standard. The number of the plurality of the pins is less than or equal to 52.

### CROSS REFERENCE TO RELATED APPLICATIONS

This application claims the benefit of U.S. Provisional Application No. 61/644,526, filed on May 9, 2012, U.S. Provisional Application No. 61/692, 689, filed on Aug. 23, 2012, and Taiwan Patent Application No. 102112809, filed on Apr. 11, 2013, the entirety of which are incorporated by reference herein.

### BACKGROUND OF THE INVENTION

1. Field of the Invention

The invention relates to a HUB control chip, and more particularly, to a HUB control chip capable of providing 1-to-4 Universal Serial Bus (USB) transmission.

2. Description of the Related Art

Universal Serial Bus (USB) is a serial bus standard for connection of an external apparatus, which provides hot plug, plug and play and other related functions.

Currently, the USB 2.0 standard may provide three transfer rates: low-speed, full-speed, and high-speed transfer rates, which support: 1.5 Mbps, 12 Mbps, and 480 Mbps data rates, respectively. However, faster transfer rates are being demanded for electronic apparatuses, due to continued advanced technological development, so that the electronic apparatuses may quickly access data from external apparatuses and subsequently perform related operations.

Therefore, the USB Implementers Forum established a next generation USB industry-standard, the USB 3.0. The USB 3.0 standard allows employment of SuperSpeed data transfer and non-SuperSpeed (i.e. USB 2.0) data transfer simultaneously, wherein SuperSpeed data transfer supports up to a 5 Gbps data rate.

Now, not only has the USB transmission technique matured and been easy designed, but its speed can also meet the requirements of most peripheral devices. However, due to the limitation of the number of USB connection ports provided by some electronic devices, such as a notebook computer, a HUB is needed to extend the number of USB connection ports for this kind of electronic devices.

### BRIEF SUMMARY OF THE INVENTION

HUB control chips are provided. An embodiment of A HUB control chip implemented in a specific package is provided. The HUB control chip comprises a plurality of transmission modules and a plurality of pins. The plurality of pins comprise a plurality of data pin groups coupled to one of the plurality of transmission modules respectively. Each of the plurality of data pin groups comprises: a first sub-group, receiving and transmitting a first pair of differential signals conforming to USB 2.0 standard; a second sub-group, receiving a second pair of differential signals conforming to USB 3.0 standard; and a third sub-group, transmitting a third pair of differential signals conforming to the USB 3.0 standard. The number of the plurality of the pins is less than or equal to 52.

Furthermore, another embodiment of a HUB control chip implemented in a specific package is provided. The HUB control chip comprises a plurality of USB transmission modules, and a plurality of the pins disposed at four sides of the specific package. Each of the USB transmission modules comprises a USB 2.0 control unit, receiving and transmitting a first pair of differential signals conforming to USB 2.0 standard and a USB 3.0 control unit, receiving a second pair of differential signals conforming to USB 3.0 standard, and transmitting a third pair of differential signals conforming to the USB 3.0 standard. The plurality of the pins comprise a plurality of data pin groups, each coupled to a corresponding USB transmission module. The plurality of data pin groups are used to receive and transmit the first, second and third pair of differential signals of the corresponding USB transmission module. The number of the plurality of the pins disposed at each side of the specific package is less than or equal to 13.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a HUB control chip according to an embodiment of the invention;

FIG. 2 shows a schematic diagram illustrating a HUB control chip consisting of 48 pins according to an embodiment of the invention;

FIG. 3 shows a pin table of the HUB control chip of FIG. 2;

FIG. 4 shows a schematic diagram illustrating a HUB control chip consisting of 48 pins according to another embodiment of the invention;

FIG. 5 shows a pin table of the HUB control chip of FIG. 4;

FIG. 6 shows a schematic diagram illustrating a HUB control chip consisting of 52 pins according to an embodiment of the invention;

FIG. 7 shows a pin table of the HUB control chip 300 of FIG. 6; and

FIG. 8 shows a circuit layout diagram of a HUB control chip according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

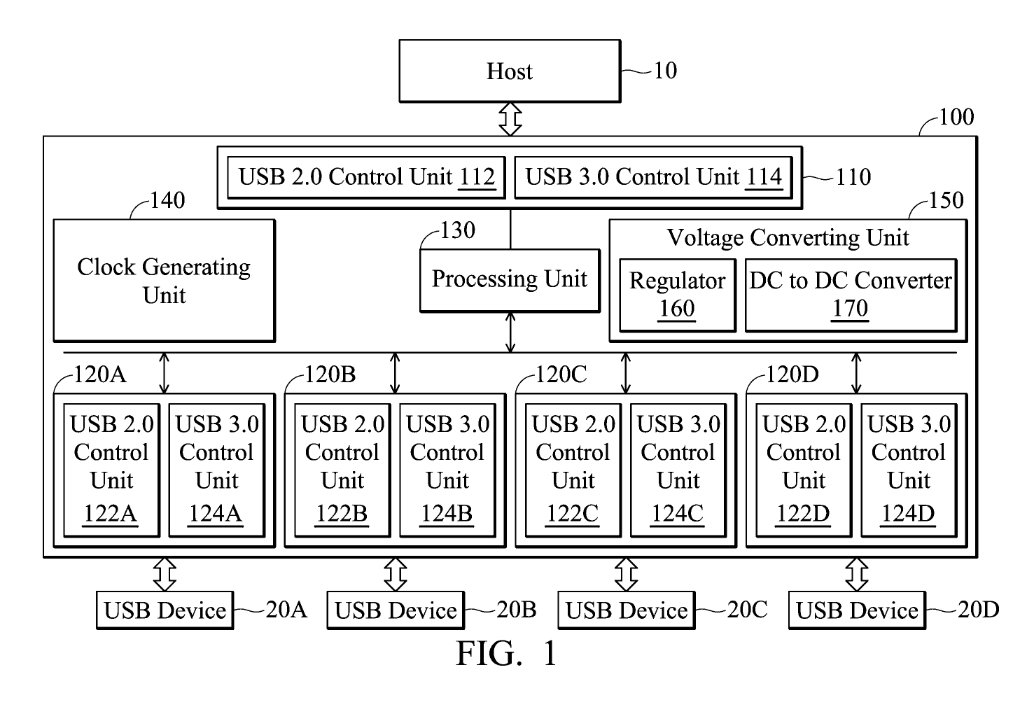

FIG. 1 shows a HUB control chip 100 according to an embodiment of the invention. In FIG. 1, the HUB control chip 100 is implemented in a motherboard or an independent device. The HUB control chip 100 comprises a plurality of Universal Serial Bus (USB) transmission modules 110 and 120A-120D, a processing unit 130, a clock generating unit 140 and a voltage converting unit 150. In the embodiment, the USB transmission module 110 is an upstream transmission module coupled to a host 10, which is used to transfer data between the processing unit 130 and the host 10. Furthermore, the USB transmission modules 120A, 120B, 120C and 120D are downstream transmission modules coupled to USB devices 20A, 20B, 20C and 20D, respectively. The transmission modules 120A, 120B, 120C and 120D are used to transfer data between the processing unit 130 and the corresponding USB device. Therefore, data can be transferred between the host 10 and the four USB devices via the HUB control chip 100. Moreover, each USB transmission module of the HUB control chip 100 comprises a USB 2.0 control unit and a USB 3.0 control unit. The USB 2.0 control unit and the USB 3.0 control unit of each USB transmission module are USB physical layer circuits (including an analog part and digital part). The USB 2.0 control unit is used to receive and transmit a pair of differential signals D+/D− conforming to the High-Speed, Full-Speed and Low-Speed specifications. The USB 3.0 control unit is used to receive a pair of differential signals SSRX+/SSRX− conforming to the SuperSpeed specification and transmit a pair of differential signals SSTX+/SSTX− conforming to the SuperSpeed specification. As shown in FIG. 1, the USB transmission module 110 comprises a USB 2.0 control unit 112 and a USB 3.0 control unit 114. The USB transmission module 120A comprises a USB 2.0 control unit 122A and a USB 3.0 control unit 124A. The USB transmission module 120B comprises a USB 2.0 control unit 122B and a USB 3.0 control unit 124B. The USB transmission module 120C comprises a USB 2.0 control unit 122C and a USB 3.0 control unit 124C, and the USB transmission module 120D comprises a USB 2.0 control unit 122D and a USB 3.0 control unit 124D. Each USB 2.0 control unit is coupled to the USB 2.0 differential pins of a USB host or a USB device, so as to transmit or receive the pair of differential signals D+/D−. Each USB 3.0 control unit is coupled to the USB 3.0 differential pair pins of USB host or the USB device, so as to receive the pair of differential signals SSRX+/SSRX− and transmit the pair of differential signals SSTX+/SSTX−. Taking the USB transmission module 110 as an example, the USB 2.0 control unit 112 receives the pair of differential signals D+/D− from the host 10 and transmits the pair of differential signals D+/D− to the host 10. The USB 3.0 control unit 114 receives the pair of differential signals SSRX+/SSRX− from the host 10 and transmits the pair of differential signals SSTX+/SSTX− to the host 10.

In FIG. 1, the processing unit 130 is coupled to the USB transmission module 110 and the USB transmission module 120A-120D. The processing unit 130 transmits the USB data from the host 10 to a designated USB device (such as one of the USB device 20A-20D), and transmits the USB data from the USB device 20A, 20B, 20C or 20D to the host 10. The clock generating unit 140 comprises an oscillator and a phase lock loop (PLL), which generates the desired clock signals to the HUB control chip 100 according to a clock input signal (e.g. provided by an external crystal). The voltage converting unit 150 comprises a regulator 160 and a DC to DC converter 170. When no external 3.3 volt voltage from the outside of the HUB control chip 100 is provided to the HUB control chip 100, the regulator 160 converts down a 5 volt voltage from a power line VBUS conforming to the USB standard into 3.3 volt voltage, so as to provide the 3.3 volt voltage to the HUB control chip 100. In an embodiment, the 3.3 volt voltage is applied to the USB 2.0 control unit 112, 122A, 122B, 122C and 122D. In one embodiment, the regulator 160 may be a low drop out (LDO) linear regulator. The DC to DC converter 170 converts down a 5 volt voltage from a power line VBUS into a voltage of a low voltage level (e.g. 1.25, 1.2, 1.15, 1.1, 1.05, 1, 0.95 or 0.9V), so as to provide the voltage with the low voltage level to the HUB control chip 100. In one embodiment, the voltage with the low voltage level from the DC to DC converter 170 is provided to the USB 3.0 control units 114, 124A, 124B, 124C and 124D. The low voltage level could be adjusted according to actual applications. That is to say, the DC to DC converter 170 can provide voltages with various voltage levels, and the DC to DC converter 170 may provide a suitable low voltage level according to voltage level requirements of the HUB control chip 100.

In one embodiment, when a 3.3 volt voltage is provided by the other circuits disposed on a printed circuit board (i.e. from the outside of the HUB control chip 100), the regulator 160 is disabled by the processing unit 130, and then the regulator 160 stops providing the 3.3 volt voltage. It is to be noted, that the DC to DC converter 170 is enabled by the processing unit 130 when the regulator 160 is disabled, and the DC to DC converter 170 continues to provide the voltage with the low voltage level, to the HUB control chip 100.

In another embodiment, if only a 5 volt voltage is provided by the printed circuit board rather than a 3.3 volt voltage, the processing unit1 130 may enable the regulator 160 and the DC to DC converter 170 of the voltage converting unit 150. Then the regulator 160 and the DC to DC converter 170 respectively generate the 3.3 volt voltage and the voltage with the low voltage level according to the 5 volt voltage. As described above, regardless of whether the printed circuit board is capable of providing the 3.3 volt voltage, the HUB control chip 100 of the invention can be implemented. Furthermore, the HUB control chip 100 may be operated in different low voltage levels under different manufacture conditions. Typically, the printed circuit board may only provide a voltage with a specific low voltage level. Once the specific low voltage level provided by the printed circuit board is not the voltage required by the HUB control chip 100. The DC to DC converter 170 implemented within the HUB control chip 100 may provide the required low voltage to the HUB control chip 100. Therefore, additional voltage converters and additional DC to DC converters are not required to be implemented in a printed circuit board, thereby decreasing costs for vendors of the printed circuit board.

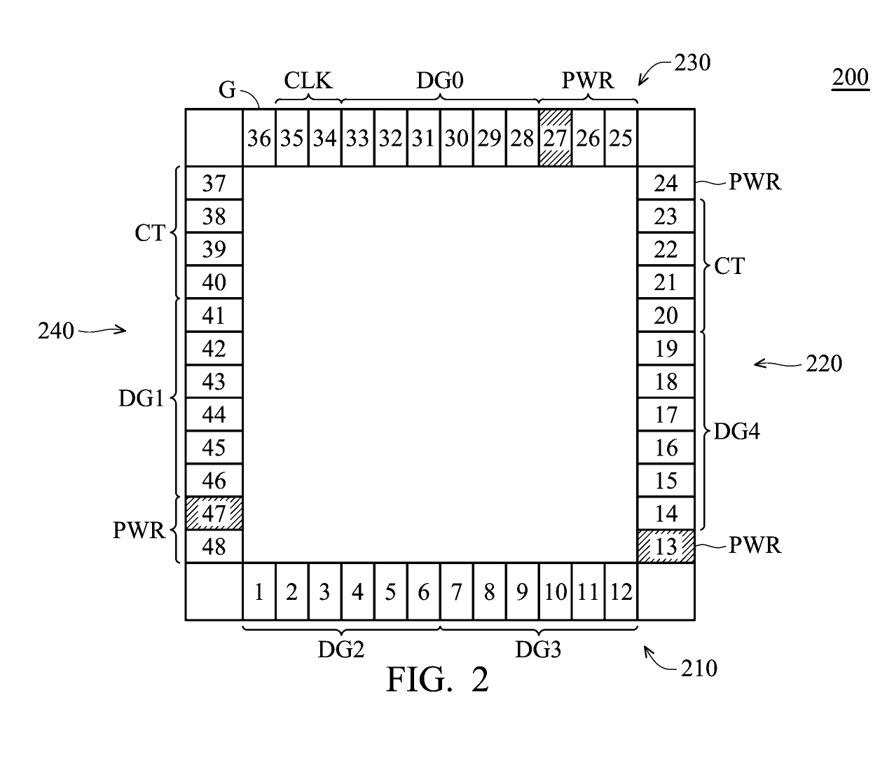

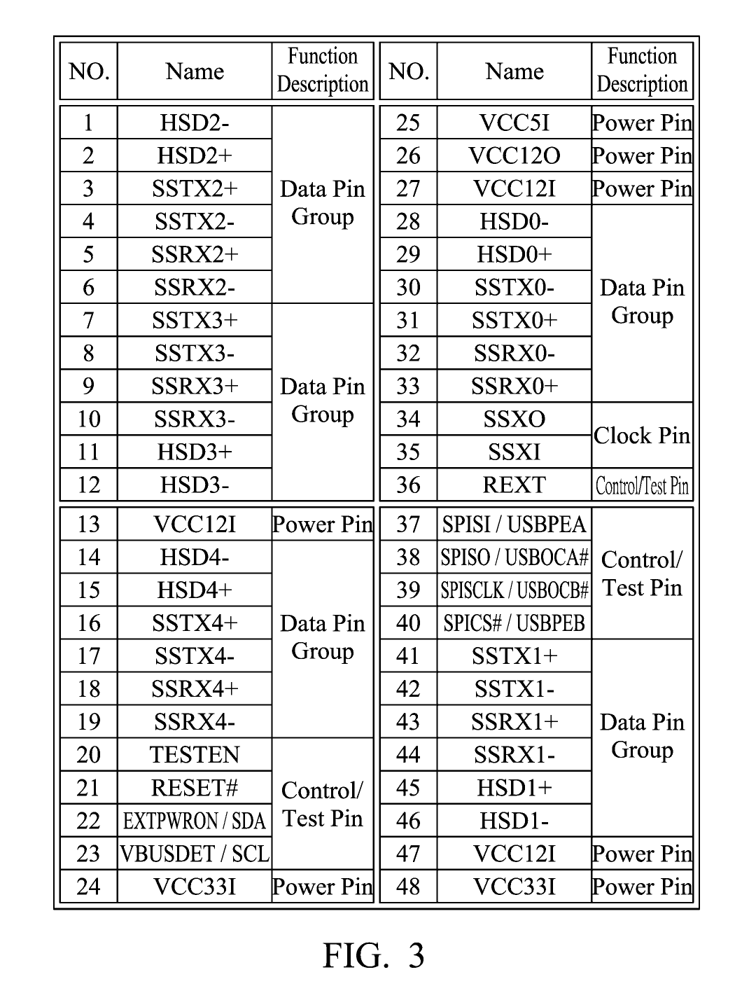

FIG. 2 shows a schematic diagram illustrating a HUB control chip 200 having 48 pins according to an embodiment of the invention, and FIG. 3 shows a pin table of the HUB control chip 200 of FIG. 2. In the embodiment, the HUB control chip 200 is implemented in a quad flat no-lead (QFN) package, and the QFN package is soldered in a printed circuit board. Each side 210, 220, 230 and 240 of the QFN package has only 12 pins. Referring to FIGS. 1-3 together, the main types of the 48 pins can be data pins, power pins PWR, clock pins CLK and control/test pins CT. For the data pins; the pins 1-6 form a data pin group DG2; the pins 7-12 form a data pin group DG3; the pins 14-19 form a data pin group DG4; the pins 28-33 form a data pin group DG0; and the pins 41-46 form a data pin group DG1. In one embodiment, the data pin group DG0 is coupled to the USB transmission module 110 of FIG. 1 for transferring data between the processing unit 130 and the host 10. The data pin groups DG1, DG2, DG3 and DG4 are respectively coupled to the USB transmission module 120A, 120B, 120C and 120D of FIG. 1, for transferring data between the processing unit 130 and the USB devices 20A-20D. In addition, each data pin group comprises six pins that are divided into three sub-groups. A first sub-group of the data pin group comprises two pins for receiving and transmitting the pair of differential signals D+/D− conforming to the High-Speed specification. A second sub-group of the data pin group comprises two pins for transmitting the pair of differential signals SSTX+/SSTX− conforming to the SuperSpeed specification. A third sub-group of the data pin group comprises two pins for receiving the pair of differential signals SSRX+/SSRX− conforming to the SuperSpeed specification. Taking the data pin group DG2 as an example, the pin 1 (HSD2−) and the pin 2 (HSD2+) form the first sub-group. The first sub-group is coupled to the USB 2.0 control unit 122B for receiving the pair of differential signals D+/D− from the USB device 20B and transmitting the pair of differential signals D+/D− to the USB device 20B. The pin 3 (SSTX2+) and the pin 4 (SSTX2−) form the second sub-group. The second sub-group is coupled to the USB 3.0 control unit 124B for transmitting the pair of differential signals SSTX+/SSTX− to the USB device 20B. The pin 5 (SSRX2+) and the pin 6 (SSRX2−) form the third sub-group. The third sub-group is coupled to the USB 3.0 control unit 124B for receiving the pair of differential signals SSRX+/SSRX− from the USB device 20B. It is to be noted, that the arranged sequence of the first, second and third sub-groups and the arranged sequence of the pins within each sub-group are used as an example, and not to limit the invention.

Furthermore, the pins 20-23 and the pins 36-40 are the control/test pins for receiving the control or test signals from the host 10. For example, the processing unit 130 receives a reset signal from the host 10 via the pin 21. Moreover, when the HUB control chip 200 is set to a serial peripheral interface (SPI) operation mode by the host 10, the HUB control chip 200 may transfer data in SPI communication protocol. For example, the processing unit 130 performs SPI communication with the host 10 or the other devices of the printed circuit board via the pins 37-40. As shown in FIG. 2 and FIG. 3, in the SPI operation mode, the pins 37-40 are the plurality of the pins for receiving and outputting the SPI data. The pin 39 is used to transmit a clock signal, and the pin 40 is a select signal pin.

In addition, the pin 36 is coupled to a device (e.g. a resistor) on the printed circuit board for voltage reference, such as a bandgap voltage. The pins 34-35 are the clock pins coupled to a crystal of the printed circuit board. The pin 35 is used to receive a clock input signal from an external crystal, and the pin 36 is used to provide a clock output signal to the external crystal.

In FIG. 2, the 48 pins do not comprise any ground pin. In the embodiment, the HUB control chip 200 is grounded by an exposed pad (E-Pad) package manner. Furthermore, the power pins of the HUB control chip 200 are divided into three types: a high-voltage power pin for providing a 5 volt voltage, a mid-voltage power pin for providing a 3.3 volt voltage, and a low-voltage power pin for providing a voltage with a low voltage level. In one embodiment, the high-voltage power pin 25 is used to receive a 5 volt voltage from a power line VBUS. In one embodiment, when a 3.3 volt voltage is provided by an external circuit (e.g. from the printed circuit board), the USB transmission modules 110, 120A, 120B, 120C and 120D receive the 3.3 volt voltage via the mid-voltage power pins 24 and 48. If the 3.3 volt voltage is provided by the regulator 160 (i.e. the external circuit is not capable of providing the 3.3 volt voltage), the mid-voltage power pins 24 and 48 are respectively coupled to capacitors of the printed circuit board, so as to regulate the voltages. The low-voltage power pins 13, 26, 27 and 47 are all coupled to the DC to DC converter 170. The low-voltage power pin 26 is an output pin, which is used to output the voltage with the low voltage level (e.g. 1.25, 1.2, 1.15, 1.1, 1.05, 1, 0.95 or 0.9V) generated by the DC to DC converter 170, to the low-voltage power pins 13, 27 and 47. The low-voltage power pins 13, 27 and 47 are the input pins for receiving the voltage with the low voltage level. Moreover, the low-voltage power pin 26 is coupled to the low-voltage power pins 13, 27 and 47 via an inductor (not shown). In general, the inductor is disposed on the printed circuit board for energy storage during the voltage converting periods of the DC to DC converter 170. The USB transmission modules 110, 120A, 120B, 120C and 120D receive the voltage with the low voltage level via the low-voltage power pins 13, 27 and 47. It is to be noted that the low-voltage power pins 13, 27 and 47 are respectively disposed at different sides of the package of the HUB control chip 200. More particularly, the low-voltage power pins 13, 27 and 47 are disposed at different corners of the package of the HUB control chip 200.

In FIG. 2, the data pin groups DG2 and DG3 are disposed at a first side 210 of the package of the HUB control chip 200. The low-voltage power pin 13, the data pin group DG4 and the mid-voltage power pin 24 are disposed at a second side 220 of the package of the HUB control chip 200. The high-voltage power pin 25, the mid-voltage power pin 27 and the data pin group DG0 are disposed at a third side 230 of the package of the HUB control chip 200. The data pin group DG1, the low-voltage power pin 47 and the mid-voltage power pin 48 are disposed at a fourth side 240 of the package of the HUB control chip 200. In other words, two data pin groups are disposed at one side of the HUB control chip 200 in FIG. 2, and the other three data pin groups are respectively disposed at the other three sides of the HUB control chip 200.

In addition, the three low-voltage power pins 13, 27 and 47 for receiving the voltage with the low voltage level, are respectively disposed at the other three sides of the HUB control chip 200, wherein each of the other three sides has a data pin group. Furthermore, the two mid-voltage power pins (i.e. the pins 24 and 48) are disposed at the opposite corners (e.g. are disposed on a diagonal line).

Specifically, the three low-voltage power pins are disposed between the data pin groups DG0-DG4 based on a specific arrangement. As shown in FIG. 2, the data pin groups DG2 and DG3 are disposed between the low-voltage power pins 13 and 47, the data pin group DG4 is disposed between the low-voltage power pins 13 and 27, and the data pin groups DG0 and DG1 are disposed between the low-voltage power pins 27 and 47. By the specific arrangement, the three low-voltage power pins 13, 27 and 47 can provide the voltage with the low voltage level to the five data pin groups. For example, the low-voltage power pin 13 is capable of providing power to the data pin groups DG3 and the data pin group DG4, the low-voltage power pin 27 is capable of providing power to the data pin group DG0, and the low-voltage power pin 47 is capable of providing power to the data pin group DG1 and the data pin group DG2. Therefore, only four low-voltage power pins are needed for the HUB control chip 200, so as to supply low voltage power for the HUB control chip 200. Thus, the number of the pins of the HUB control chip 200 can be decreased to 48. The four low-voltage power pins comprise the three low-voltage power pins 13, 27 and 47 for receiving the voltage with the low voltage level and the one low-voltage power pin 26 for outputting the voltage with the low voltage level. The 48 pins comprise 30 data pins (five data pin groups, wherein each data pin group comprises 6 data pins), 9 control/test pin (the pins 20-23 and the pins 36-40), two clock pins (pins 34 and 35) and 7 power pins (the high-voltage power pin 25, the mid-voltage power pins 24 and 48, and the low-voltage power pins 13, 26, 27 and 47).

The three low-voltage power pins 13, 27 and 47 with the specific arrangement can provide power to the five data pin groups. Taking the arrangement of FIG. 2 as an example, the specific arrangement is in a sequence as DG2, DG3, PWR (pin 13), DG4, PWR (pin 27), DG0, DG1 and PWR (pin 47). Therefore, the specific arrangement indicates that at least one low-voltage power pin is disposed between the two adjacent data pin groups, and the low-voltage power pin is used to provide power to the two adjacent data pin groups. As shown in FIG. 2, in the embodiment, two low-voltage power pins are respectively disposed between corresponding two adjacent data pin groups: the power pin 13 is adjacent to the data pin groups DG3 and DG4, and the power pin 47 is adjacent to the data pin groups DG1 and DG2. In one embodiment, that the specific arrangement only comprises the plurality of low-voltage power pins and the plurality of data pin groups, and the specific arrangement does not comprise the arrangement of the control/test pins, the clock pins, the high-voltage power pin and the plurality of mid-voltage power pins. Furthermore, in the specific arrangement, each low-voltage power pin is adjacent to a data pin group for providing power to the adjacent data pin group. Moreover, according to the specific arrangement, a user can adjust the relative position or absolute position of the plurality of the pins of the HUB control chip 200, for example, by swapping the adjacent two pins or two data pin groups, or rotating or shifting the sequence of the plurality of the pins.

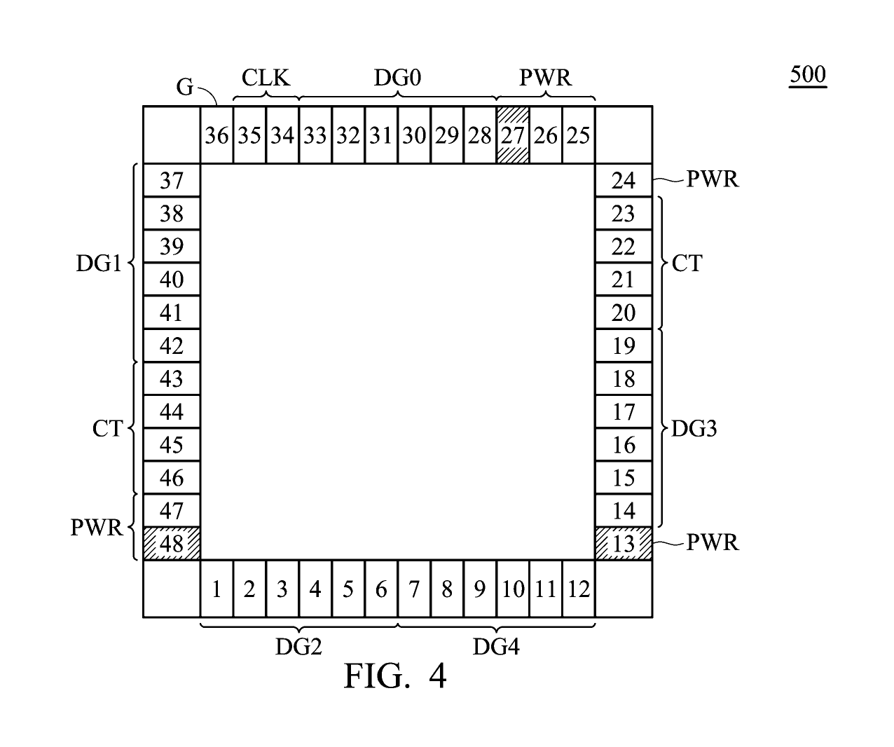

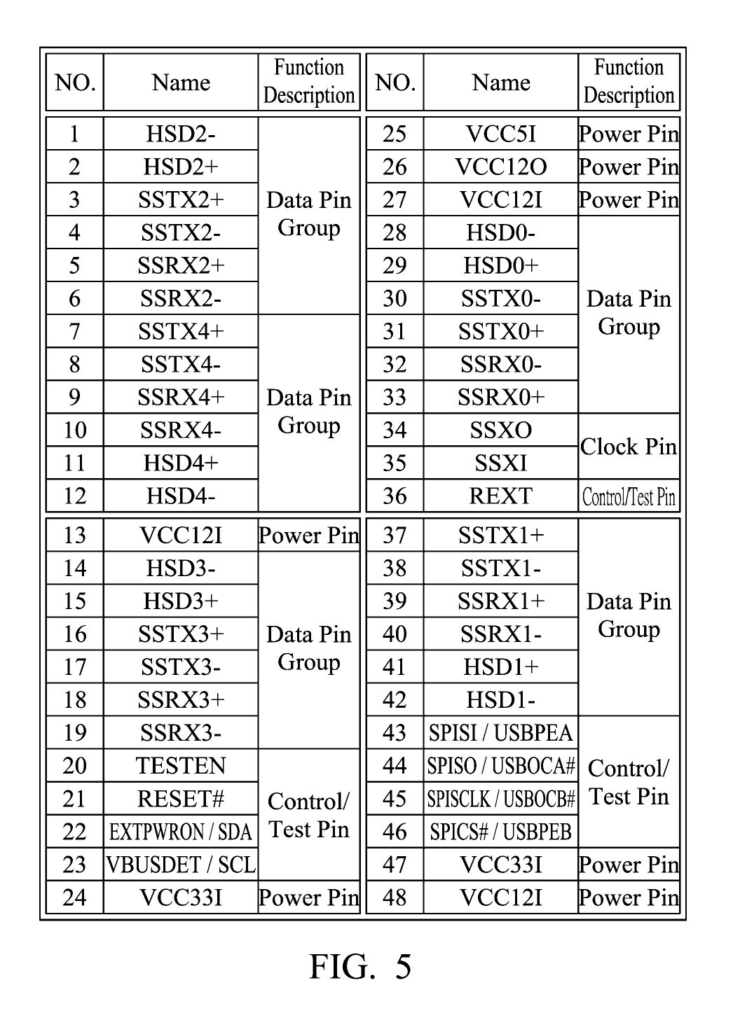

FIG. 4 shows a schematic diagram illustrating a HUB control chip 500 having 48 pins according to another embodiment of the invention, and FIG. 5 shows a pin table of the HUB control chip 500 of FIG. 4. Compared to the HUB control chip 200, the differences between the HUB control chips 200 and 500 are that the positions of the data pin group DG3 and the data pin group DG4 are swapped, the positions of the control/test pins 37-40 and the data pin group DG1 are swapped, and, the positions of the power pin 48 and the power pin 47 are swapped. The rest of the plurality of the pins are the same, and will not be described herein. Although the HUB control chip 500 of FIG. 4 and the HUB control chip 200 of FIG. 2 have different pin arrangements, the plurality of data pin groups and the plurality of low-voltage power pins still have the same specific arrangement, as described in FIG. 2.

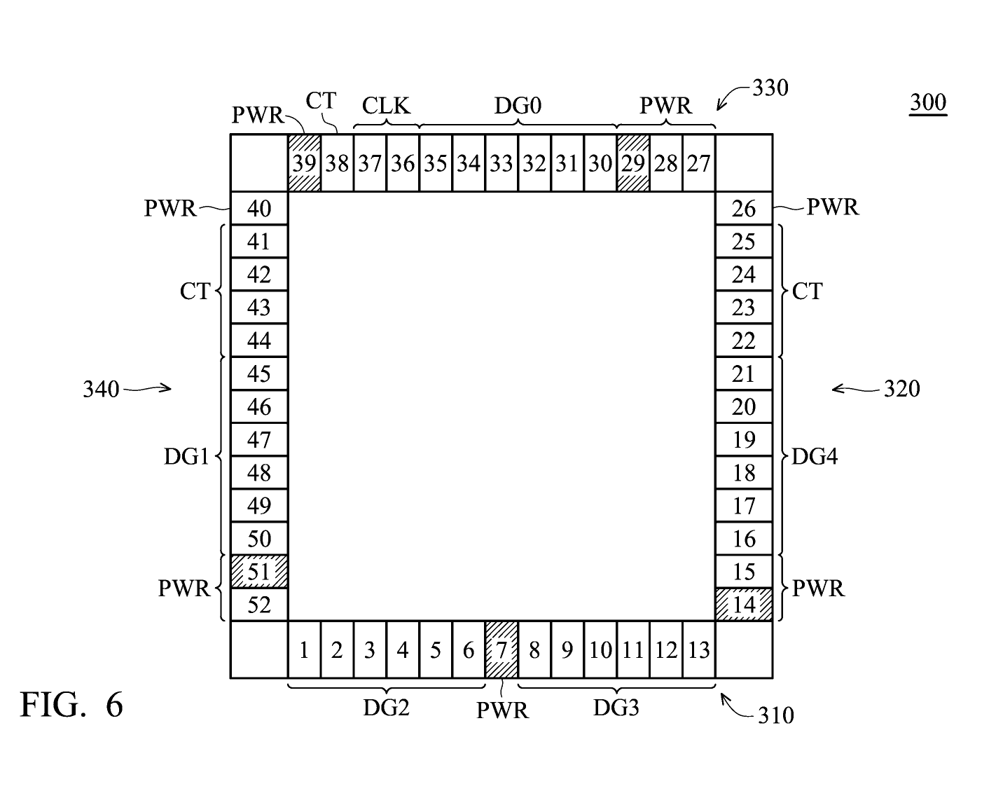

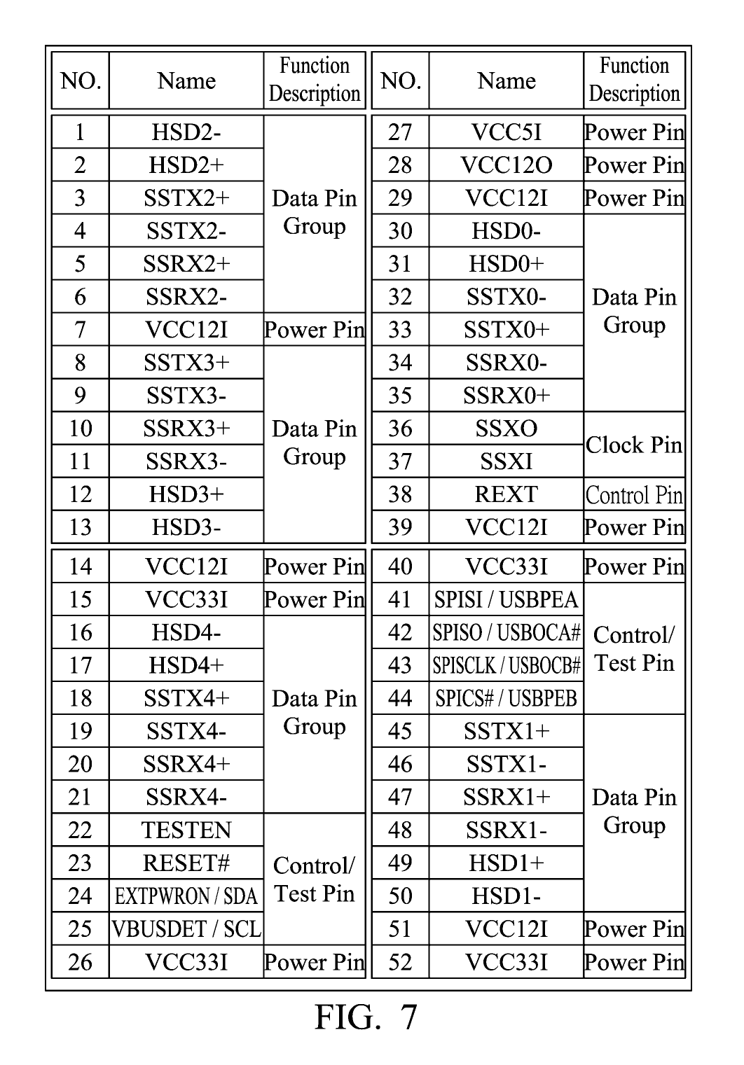

FIG. 6 shows a schematic diagram illustrating a HUB control chip 300 having 52 pins according to an embodiment of the invention, and FIG. 7 shows a pin table of the HUB control chip 300 of FIG. 6. In the embodiment, the HUB control chip 300 is implemented in a QFN package, and the QFN package is soldered in a printed circuit board. Each side 310, 320, 330 and 340 of the QFN package has only 13 pins. Similarly, the main types of the 52 pins can be data pins, power pins PWR, clock pins CLK and control/test pins CT. As described above, the data pin groups DG0, DG1, DG2, DG3 and DG4 correspond to the USB transmission modules 110, 120A, 120B, 120C and 120D of FIG. 1, respectively. In addition, each data pin group comprises six pins that are divided into three sub-groups. It is to be noted, that the arranged sequence of the first, second and third sub-groups and the arranged sequence of the pins within each sub-group are used as an example, and not to limit the invention. Compared to the HUB control chip 200 of FIG. 2, the HUB control chip 300 further comprises two mid-voltage power pins (e.g. the pins 15 and 40) for receiving the 3.3 volt voltage, and two low-voltage power pins (e.g. the pins 7 and 39) for receiving the voltage with the low voltage level. The low-voltage power pins 7, 14, 28, 29, 39 and 51 are all coupled to the DC to DC converter 170. The low-voltage power pin 28 is an output pin, which is used to output the voltage with the low voltage level (e.g. 1.25, 1.2, 1.15, 1.1, 1.05, 1, 0.95 or 0.9V) generated by the DC to DC converter 170, to the low-voltage power pins 7, 14, 29, 39 and 51. The low-voltage power pins 7, 14, 29, 39 and 51 are input pins for receiving the voltage with the low voltage level. Moreover, the low-voltage power pin 28 is coupled to the low-voltage power pins 7, 14, 29, 39 and 51 via an inductor (not shown). In general, the inductor is disposed on the printed circuit board for energy storage during the voltage converting periods of the DC to DC converter 170. The USB transmission modules 110, 120A, 120B, 120C and 120D receive the voltage with the low voltage level via the low-voltage power pins 7, 14, 29, 39 and 51, and the USB transmission modules 110, 120A, 120B, 120C and 120D receive the 3.3 volt voltage via the mid-voltage power pins 15, 26, 40 and 52.

In FIG. 6, the data pin groups DG2 and DG3 and the low-voltage power pin 7 are disposed at a first side 310 of the package of the HUB control chip 300. The low-voltage power pin 14, the mid-voltage power pin 15, the data pin group DG4 and the mid-voltage power pin 26 are disposed at a second side 320 of the package of the HUB control chip 300. The high-voltage power pin 27, the mid-voltage power pin 29, the data pin group DG0 and the low-voltage power pin 39 are disposed at a third side 330 of the package of the HUB control chip 300. The mid-voltage power pin 40, the data pin group DG1, the low-voltage power pin 51 and the mid-voltage power pin 52 are disposed at a fourth side 340 of the package of the HUB control chip 300. It is to be noted that each of the low-voltage power pins 7, 14, 29, 39 and 51 is disposed between the two data pin groups, respectively. Furthermore, two data pin groups are disposed at one side of the HUB control chip 300 of FIG. 6, and the other three data pin groups are respectively disposed at the other three sides of the HUB control chip 300.

In summary, the number of the pins of the HUB control chip 200 of FIG. 2, the HUB control chip 500 of FIG. 4 or the HUB control chip 300 of FIG. 6 is smaller than or equal to 52, and the number of the pins can be decreased to 48. According to the embodiments, the HUB control chip substantially decreases the number of the required pins (the data pins, the power pins, the clock pins and the control/test pins etc.) for a 1-to-4 USB 3.0 HUB (e.g. a USB 3.0 4-ports HUB). For a QFN package, the number of the plurality of the pins disposed at each side of the package is less than or equal to 13, and the plurality of the pins can be disposed at the four sides of a 6×6 mm package size. Compared to the conventional HUB control chip having more pins (e.g. 64, 68, 76, 80 or 88 pins), at least a 8×8 mm package size is needed when a QFN packaging process is performed. Therefore, according to the HUB control chips of the invention, package size and cost are decreased. In addition, the number of the layers of a printed circuit board can be decreased to two layers by arranging the traces of the printed circuit board according to the pin arrangements, as described above, thereby decreasing manufacturing costs.

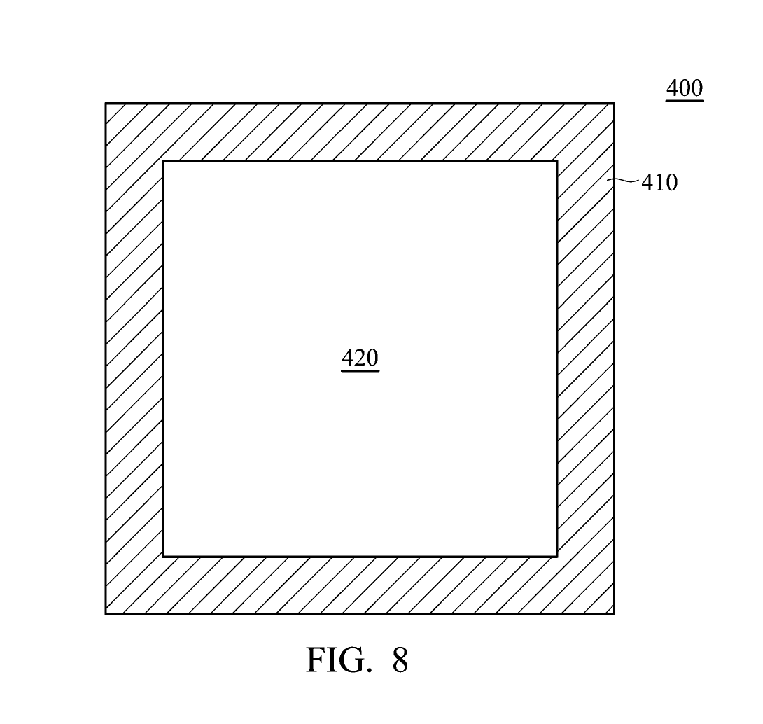

FIG. 8 shows a circuit layout diagram of a HUB control chip 400 according to an embodiment of the invention. The HUB control chip 400 comprises an analog part 410 and a logic core part 420. In the embodiment, the analog part 410 is disposed at the periphery of the HUB control chip 400, and surrounds the logic core part 420. Thus, the power voltages (e.g. the 5 volt voltage, the 3.3 volt voltage and the voltage with the low voltage level) from the power pins (e.g. the high-voltage, mid-voltage and low-voltage pins) can be averagely shared between the circuits of the analog part 410 and the logic core part 420.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A HUB control chip implemented in a specific package, comprising:
a plurality of transmission modules; and
a plurality of pins, comprising:
a plurality of data pin groups coupled to one of the plurality of transmission modules respectively, wherein each of the plurality of data pin groups comprises:
a first sub-group, receiving and transmitting a first pair of differential signals conforming to USB 2.0 standard;
a second sub-group, receiving a second pair of differential signals conforming to USB 3.0 standard; and
a third sub-group, transmitting a third pair of differential signals conforming to the USB 3.0 standard,
wherein the number of the plurality of the pins is less than or equal to 52.

2. The HUB control chip as claimed in claim 1, wherein the plurality of the pins further comprises:
a high-voltage power pin;
a plurality of mid-voltage power pins; and
a plurality of low-voltage power pins,
wherein a first voltage applied to the high-voltage power pin is larger than a second voltage applied to the plurality of mid-voltage power pins, and the second voltage is larger than a third voltage applied to the plurality of low-voltage power pins, and
wherein the number of the plurality of mid-voltage power pins is less than the number of the plurality of low-voltage power pins, and the number of the plurality of low-voltage power pins is less than or equal to 5.

3. The HUB control chip as claimed in claim 2, further comprising:
a regulator coupled to the high-voltage power pin and the plurality of mid-voltage power pins, converting down the first voltage to the second voltage; and
a DC to DC converter coupled to the high-voltage power pin and the plurality of low-voltage power pins, converting down the first voltage to the third voltage.

4. The HUB control chip as claimed in claim 2, wherein each of the transmission modules comprises:
a USB 2.0 control unit, wherein the USB 2.0 control unit is powered by the second voltage; and
a USB 3.0 control unit, wherein the USB 3.0 control unit is powered by the third voltage.

5. The HUB control chip as claimed in claim 2, wherein the transmission modules comprises a first transmission module, a second transmission module, a third transmission module, a fourth transmission module, and a fifth transmission module, and
wherein when the number of the plurality of the pins is equal to 48 and the number of the plurality of low-voltage power pins is equal to 3, the plurality of data pin groups corresponding to the first and second transmission modules are disposed between a first low-voltage power pin and a second low-voltage power pin of the plurality of low-voltage power pins, the data pin group corresponding to the third transmission module is disposed between the first low-voltage power pin and a third low-voltage power pin of the plurality of low-voltage power pins, and the plurality of data pin groups corresponding to the fourth and fifth transmission modules are disposed between the third low-voltage power pin and the second low-voltage power pin of the plurality of low-voltage power pins.

6. The HUB control chip as claimed in claim 2, wherein when the number of the plurality of the pins is equal to 48 and the number of the plurality of low-voltage power pins is equal to 3, at least one of the plurality of low-voltage power pins is disposed between two adjacent data pin groups.

7. The HUB control chip as claimed in claim 2, wherein the transmission modules comprises a first transmission module, a second transmission module, a third transmission module, a fourth transmission module, and a fifth transmission module,
wherein the specific package has four sides, and
wherein when the number of the plurality of the pins is equal to 48 or 52, the plurality of data pin groups corresponding to the first and second transmission modules are disposed at a first side of the specific package, the data pin group corresponding to the third transmission module is disposed at a second side of the specific package, the data pin group corresponding to the fourth transmission module is disposed at a third side of the specific package, and the data pin group corresponding to the fifth transmission module is disposed at a fourth side of the specific package.

8. The HUB control chip as claimed in claim 7, wherein when the number of the plurality of the pins is equal to 48 and the number of the plurality of low-voltage power pins is equal to 3, a first low-voltage power pin of the plurality of low-voltage power pins is disposed at the second side of the specific package, a second low-voltage power pin of the plurality of low-voltage power pins is disposed at the third side of the specific package, and a third low-voltage power pin of the plurality of low-voltage power pins is disposed at the fourth side of the specific package.

9. The HUB control chip as claimed in claim 1, wherein one of the transmission modules is an upstream transmission module coupled to a host, and the other transmission modules are the downstream transmission modules, each coupled to a USB device.

10. The HUB control chip as claimed in claim 9, further comprising:
a clock generating unit coupled to a first clock pin and a second clock pin of the plurality of the pins, providing at least a clock signal to the upstream transmission module and the downstream transmission modules according to a clock input signal from the first clock pin.

11. The HUB control chip as claimed in claim 1, wherein the plurality of the pins does not comprise a ground pin.

12. The HUB control chip as claimed in claim 1, wherein the specific package is a quad flat no-lead package.

13. A HUB control chip implemented in a specific package, comprising:
a plurality of USB transmission modules, wherein each of the USB transmission modules comprises:
a USB 2.0 control unit, receiving and transmitting a first pair of differential signals conforming to USB 2.0 standard; and
a USB 3.0 control unit, receiving a second pair of differential signals conforming to USB 3.0 standard, and transmitting a third pair of differential signals conforming to the USB 3.0 standard; and
a plurality of pins disposed at four sides of the specific package, wherein the plurality of pins comprise:
a plurality of data pin groups, each coupled to a corresponding USB transmission module, wherein the plurality of data pin groups are used to receive and transmit the first, second and third pair of differential signals of the corresponding USB transmission module,
wherein the number of the plurality of the pins disposed at each side of the specific package is less than or equal to 13.

14. The HUB control chip as claimed in claim 13, wherein each of the plurality of data pin groups comprises:
a first sub-group coupled to the USB 2.0 control unit of the corresponding USB transmission module, receiving and transmitting the first pair of differential signals;
a second sub-group coupled to the USB 3.0 control unit of the corresponding USB transmission module, receiving the second pair of differential signals; and
a third sub-group coupled to the USB 3.0 control unit of the corresponding USB transmission module, transmitting the third pair of differential signals.

15. The HUB control chip as claimed in claim 13, wherein one of the USB transmission modules is coupled to a host, and the other USB transmission modules are coupled to USB devices, respectively.

16. The HUB control chip as claimed in claim 13, wherein the plurality of the pins further comprise:
a high-voltage power pin;
a plurality of mid-voltage power pins; and
a plurality of low-voltage power pins,
wherein a first voltage applied to the high-voltage power pin is larger than a second voltage applied to the plurality of mid-voltage power pins, and the second voltage is larger than a third voltage applied to the plurality of low-voltage power pins, and
wherein the number of the plurality of mid-voltage power pins is less than the number of the plurality of low-voltage power pins, and the number of the plurality of low-voltage power pins is less than or equal to 5.

17. The HUB control chip as claimed in claim 16, further comprising:
a regulator coupled to the high-voltage power pin and the plurality of mid-voltage power pins, converting down the first voltage into the second voltage; and
a DC to DC converter coupled to the high-voltage power pin and the plurality of low-voltage power pins, converting down the first voltage to the third voltage.

18. The HUB control chip as claimed in claim 16, wherein the USB 2.0 control unit is powered by the second voltage, and the USB 3.0 control unit is powered by the third voltage.

19. The HUB control chip as claimed in claim 16, when the number of the plurality of the pins is equal to 48 and the number of the plurality of low-voltage power pins is equal to 3, the plurality of data pin groups corresponding to a first module and a second module of the USB transmission modules are disposed between a first low-voltage power pin and a second low-voltage power pin of the plurality of low-voltage power pins, the data pin group corresponding to a third module of the USB transmission modules is disposed between the first low-voltage power pin and a third low-voltage power pin of the plurality of low-voltage power pins, and the plurality of data pin groups corresponding to a fourth module and a fifth module of the USB transmission modules are disposed between the third low-voltage power pin and the second low-voltage power pin of the plurality of low-voltage power pins.

20. The HUB control chip as claimed in claim 16, wherein when the number of the plurality of the pins is equal to 48 and the number of the plurality of low-voltage power pins is equal to 3, at least one of the plurality of low-voltage power pins is disposed between two adjacent data pin groups.
